(19) United States
(12) Patent Application Publication
(10) Pub. No.: US 2004/0156554 A1
(43) Pub. Date: Aug. 12, 2004

(54) System and method for simulating visual defects

(76) Inventor: David J. McIntyre, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/687,525

(22) Filed: Oct. 15, 2003

Related U.S. Application Data
(60) Provisional application No. 60/418,576, filed on Oct. 15, 2002.

(51) Int. Cl. G06K 9/40

(52) U.S. Cl. 382/254

(57) ABSTRACT

A system and method for simulating defects of visual function are provided. In one aspect, the invention provides a computer system for simulating visual defects including a device for obtaining an input image, a memory, a processing unit, means for modifying the input image to simulate a visual defect, and a display device. In another aspect, the invention provides methods for simulating a visual defect to a user which involves obtaining an input image, selecting a visual defect filter set to apply, processing and displaying the modified image.

### CROSS-REFERENCE TO RELATED APPLICATION

This application claims the benefit of U.S. Provisional Application No. 60/418,576 filed September Oct. 15, 2002.

### FIELD OF THE INVENTION

This invention relates to methods and systems for simulating defects of visual function through the use of computer generated image modification.

### BACKGROUND OF THE INVENTION

Visual impairment, whether resulting from disease or therapeutic modality, is beyond the personal experience of most members of the general public. Therefore, the lack of shared experience between those with normal sight and those who experience visual impairment often results in misunderstanding and difficulty in communication regarding the effects of visual loss on the ability to carry out daily life.

The various abnormal conditions and diseases which affect visual function produce a wide variety of distinctly different patterns of visual loss. Thus far, visual defects have been represented by artwork on static illustrations, such as for example, a photograph with a superimposed central dark spot intended to represent macular degeneration. However, the normally sighted observer of such a photograph scans it with his point of fixation, and although the observer studies the central defect and its position and edges, the rest of the unmodified peripheral areas are still filled with detail which are also carefully examined, such that the observer completely misses the overall effect of the visual loss. Moreover, by only looking at static images, there is no understanding of the difficulties the visually disabled encounter in everyday tasks. For example, the lack of constant relationship between the observer's point of fixation and the illustrated abnormality of visual function makes it impossible to understand the patient's hazard in driving with a peripheral field defect, the frustration in daily life caused by the scotoma of macular degeneration, or the frightening sudden onset of the scintillations and scotoma of an ocular migraine. Therefore, there is a need for a better understanding of visual loss by those with normal vision in order to better assist and empathize with those who are visually disabled. Additionally, patients at the onset of progressive vision impairing diseases have great difficulty understanding the gravity of their disorder. An accurate demonstration of their anticipated visual loss will not only aid them in understanding the potential limitations to their life-style, but also will enhance their compliance with long term medical care and therapy.

### SUMMARY OF THE INVENTION

In one aspect, the invention provides a computer system for simulating visual defects to a user, comprising means for obtaining an input digital image, a memory, a processing unit, means of modifying said input image to simulate a visual defect and a display device to display said modified image to the user to simulate the visual defect. In some embodiments, the system further comprises an eye tracking device which measures the user's point of fixation. In some embodiments, the simulation is presented to the user as a virtual experience in a wide field-of-view display, such as a head-mounted display.

In another aspect, the present invention provides methods for simulating a visual defect to a user. The methods of this aspect of the invention comprise obtaining an input digital image, selecting a visual defect filter set to apply to the input image, processing the image with the filter set to generate a modified digital image and displaying the modified image to the user to simulate the visual defect. In some embodiments, the method further comprises tracking at least one of the user's eyes to determine the user's point of fixation and dynamically processing the displayed image with the eye tracking data to maintain a constant orientation between the simulated visual defect and the user's point of fixation.

The system and methods of the invention may be practiced by any user who would benefit from a better understanding of a visual defect, such as families of patients suffering from visual defects, medical personnel and the general public.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a computer system for generating visual defects;

FIG. 2 is a block diagram of an illustrative architecture for a computer of FIG. 1 that generates modified digital images in accordance with the present invention;

FIG. 3 is a block diagram of the visual image modification system of FIG. 1 illustrating the transfer of a visual defect filter set between a client server and a remote service provider;

FIG. 4 is a flow diagram of a visual defect processing routine in accordance with the present invention;

FIG. 5 is a flow diagram of a visual defect processing routine with integrated field of view adjustment in accordance with the present invention;

FIG. 6 is a flow diagram of a visual defect processing routine with preprocessing and storage of images in various fields of view in accordance with the present invention;

FIG. 7 is a flow diagram of an illustrative visual defect processing subroutine for cataract simulation;

FIG. 8 is a flow diagram of a visual defect processing routine for merging a mask image with an input image; and

FIG. 9 provides data showing the effect of various filter kernel sizes on visual acuity. The x-axis shows eccentricity measured in degrees from the foveal center. The y-axis shows the level of visual acuity. The normal level of visual acuity is plotted in comparison to a digital image processed with various filter kernel sizes.

### DETAILED DESCRIPTION OF THE PREFERRED EMBODIMENT

Unless specifically defined herein, all terms used herein have the same meaning as they would to one skilled in the art of the present invention. The following definitions are provided in order to provide clarity with respect to the terms as they are used in the specification and claims to describe the present invention.

As used herein, the term “point of fixation” refers to the point on the retina (the macula) at which the rays coming from an object regarded directly are focused. The point of fixation is approximately in the center of a field of view.

As used herein, the term “field of view” refers to all of the points of an environment that can be perceived by a stable eye at a given moment, wherein the center of the field of view is approximately the point of fixation.

As used herein, the term “defect generator” refers to a processor that applies either a filter kernel, or a mask image, or both, to an input digital image resulting in a modified output image.

As used herein, the term “filter kernel” refers to an algorithm in a logic device that transforms a digital image according to a chosen set of parameters.

As used herein, the term “filter set” refers to a set of filter kernel processing steps that simulate a particular vision defect. It will be appreciated that a particular filter set may correspond to one point in a continuum during a disease progression, therefore multiple filter sets may be used to simulate the entire continuum of a particular disease progression.

As used herein, the term “mask” refers to an image which has been created to simulate a particular visual abnormality which may be superimposed or merged with another image to simulate a visual defect.

As used herein, the term “real image” refers to an image which is a 2-D representation that has light rays coming off the entire 2D plane of the object that is captured directly by the eye and forms a real image on the retina.

As used herein, the term “virtual image” refers to an image which is not a real image. Examples of virtual images include anything generated by computers, displays and sensors, or anything reflected from a mirror, piece of glass or scanned such that no original object ever exists at any single moment.

As used herein, the term “visual defect” refers to any visual impairment that may occur in human subjects, including disease-produced defects, visual loss due to injury or loss due to a therapeutic procedure or experimental device.

As used herein, the term “strabismus” refers to a deviation of the alignment of one eye in relation to the other.

As used herein, the term “amblyopia” refers to reduced visual acuity in one eye caused by lack of use of that eye in early childhood.

As used herein, the term “scotoma” refers to holes, or blind spots in the visual field in which visual acuity is reduced or absent.

As used herein, the term “nystagmus” refers to a rapid involuntary oscillation of the eyes.

Generally described, the present invention provides a system and methods for simulating a visual defect to a user. In one aspect, the invention provides a computer system for simulating visual defects to a user comprising means for obtaining an input digital image, a memory, a processing unit, means of modifying said input image to simulate a visual defect and a display device to display said modified image to the user to simulate the visual defect. In some embodiments, the system further comprises an eye tracking device which measures the user's point of fixation. In some embodiments, the simulation is presented to the user as a virtual experience in a wide field-of-view display, such as a head-mounted display. In another aspect, the present invention provides methods for simulating a visual defect to a user. The methods of this aspect of the invention comprise obtaining an input digital image, selecting a visual defect filter set to apply to the input image, processing the image with the filter set to generate a modified image and displaying the modified image to the user to simulate the visual defect.

The system and methods of the invention may be practiced by any user who would benefit from a better understanding of a visual defect, such as, for example, use by the general public and medical practitioners as an educational tool, as well as a patient's family members, counselors, members of a jury, and support group members. The systems and methods of the invention may be used to demonstrate a particular visual defect to a normally sighted person, or to simulate to a patient suffering from a visual defect how a particular defect may progress over time. In addition, the system and methods of the invention may be used by researchers, physicians and potential recipients of emerging therapeutic technologies to evaluate and understand the effect of a treatment benefit superimposed on a diseased condition, as well as to simulate possible new defects caused by a treatment. The system and methods of the invention are also useful when a therapy, such as refractive surgery, is contemplated and informed consent from the patient to the doctor is required. In this context, the simulation of potential visual problems will enhance the level of patient education and allow the patient to objectively assess the result of prospective surgery or treatment. The system and methods of the invention may also be used to simulate future assistive technologies and vision prosthetic devices for the purpose of educating the viewer about how an individual would see the world using a prosthetic device.

The system and methods of the invention may be used to simulate a wide variety of visual defects. For example, millions of patients are affected by cataracts and macular degeneration which produce visual defects that are difficult for medical personnel and the families of patients to understand and appreciate. Through the use of computer generated image modification in accordance with the system and methods of the present invention, a wide range of visual abnormalities can be simulated such as, for example, a general loss of resolution and/or contrast over the entire field, focal areas of loss of resolution and/or contrast, areas of superimposed scintillation or scotoma, areas of wavy distortion or areas of apparent magnification.

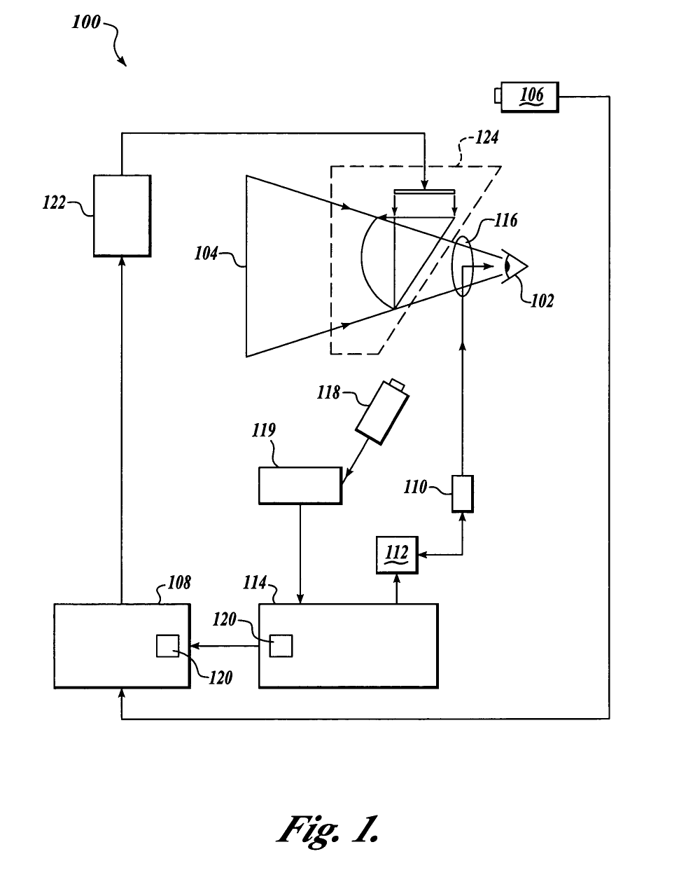

FIG. 1 illustrates one exemplary embodiment of a system 100 and hardware in accordance with the computer system of the present invention. In the embodiment shown in FIG. 1, user's eye 102 is viewing virtual image 104, while video camera 106 provides an input digital image to computer 108. An optional eye tracking device is integrated into the system wherein an infrared light source 110 is controlled by an infrared control unit 112 connected to computer 114. The infrared light source 110 shines infrared light onto dichroic see-through mirror 116, illuminating the user's eye 102. An eye-camera 118 captures a video image of the user's illuminated eye 102 reflected off mirror 116 and sends the video image via the eye camera control unit 119 into computer 114 which processes the pupil position to determine the user's point of fixation 120 and sends the user's point of fixation 120 coordinates to computer 108 which integrates point of fixation 120 with the input digital image from camera 106 and modifies the input digital image using a defect generator as discussed below to generate a modified digital image. The modified image is sent to display control unit 122 and displayed on display unit 124, allowing the user to view the displayed modified virtual image 104.

In the embodiment shown in FIG. 1, video camera 106 may be a commercially available digital video camera such as, for example, a CCD camera (available from ELMO USA, Painview, N.Y.), or a CMOS camera (available from IC Media Corp., San Jose, Calif.). In some embodiments, video camera 106 is mounted to a wearable headpiece. In some embodiments, the input digital image is captured in stereo using two cameras. In some embodiments, the input digital image is a live image captured by the user. In other embodiments, means for obtaining an input digital image includes any source that produces a digital image, such as, for example, a digitized still image, a stored digital image, a computer generated image or a live video digital image such as a television, a computer, a digital camera, digital video recorder, digital video disk (DVD) player and the like.

In the embodiment of the system of the invention shown in FIG. 1, an eye tracking device is integrated into the system, however, an eye tracking device is not required in some embodiments of the system. Eye-tracking may be monocular or binocular. In the embodiment of the invention shown in FIG. 1, eye-tracking camera 118 may be a commercial high-speed camera that determines pupil direction by measuring the relative position of the pupil with respect to eye position at high frame rates, such as a video-based corneal reflection unit, available from ISCAN® as further described in Example 1. Tracking the pupil direction of the user's eye 102 may be also be accomplished using any eye tracking device that tracks the user's gaze angle or eye position while viewing the display device 124. Other examples of eye trackers useful in the system of the invention include contact lens with light reflectors or emitters, wherein the light emitter can be powered by an optical beam striking a photodiode/light emitting diode combination along with a camera or photo sensor to measure point source movement. Other types of eye trackers useful in the system include a remote eye tracking device which is placed in front of the user below the line of sight and automatically tracks the user's eye position using a computerized fast tracking mirror system (such as the iView®, available from SensoMotoric Instruments, Berlin Germany). In some embodiments the eye tracker is binocular wherein each of the binocular video eye trackers is composed of a miniature camera and infrared light sources, with the dual optics assemblies connected to a dedicated personal computer (PC). The eye imaging cameras capture images of the eyes reflected by a dichroic mirror placed behind a head mounted display set of lenses. In some embodiments of the system, the same camera is used for illumination of the user's eye in infrared and imaging the user's eye in the visible spectrum. In some embodiments, the system also includes a head tracker.

The user's pupil position information is processed in computer 114 into point of fixation coordinates 120 which are relayed to computer 108. In some embodiments, computer 114 contains a processor that operates at a sufficient rate to process pupil position in real time, such as, for example a processor that operates at a sample rate of 60 Hz (RK-726PCI High Resolution Pupil/Corneal Reflection Processor available from ISCAN®). In some embodiments, the same computer may process both pupil position and generate modified images. In some embodiments, a monitor may be attached to computer 114 which displays the image from the eye tracking camera.

With continued reference to FIG. 1, display device 124 displays the modified image 104 to the user 102. In some embodiments, display device 124 is a wide field of view stereographic display which contains see-through lenses. In one embodiment, the display device is a head mounted display device with a resolution of at least 800×600 pixels which also includes an eye tracking system such as described in U.S. Pat. No. 6,433,760. The display device may contain a see-through display surface or an occluded display surface. Other display devices useful in the system include a wide field of view display created by rear projection onto a translucent dome. Eye tracking may be integrated with a dome display by utilizing an infrared beam splitter “hot” mirror before the user's eye. The infrared light source 110 projects a pattern of infrared fiducials onto the cornea of the user, the array consisting of six or more points on a circle surrounding a single point. The reflection of this array is then read by a high frequency eye-tracking camera 118, such as a CMOS camera, which is then input into computer 114 which calculates the relative position of fiducials and their centroids with the pupil and thus identifies the user's point of fixation 120.

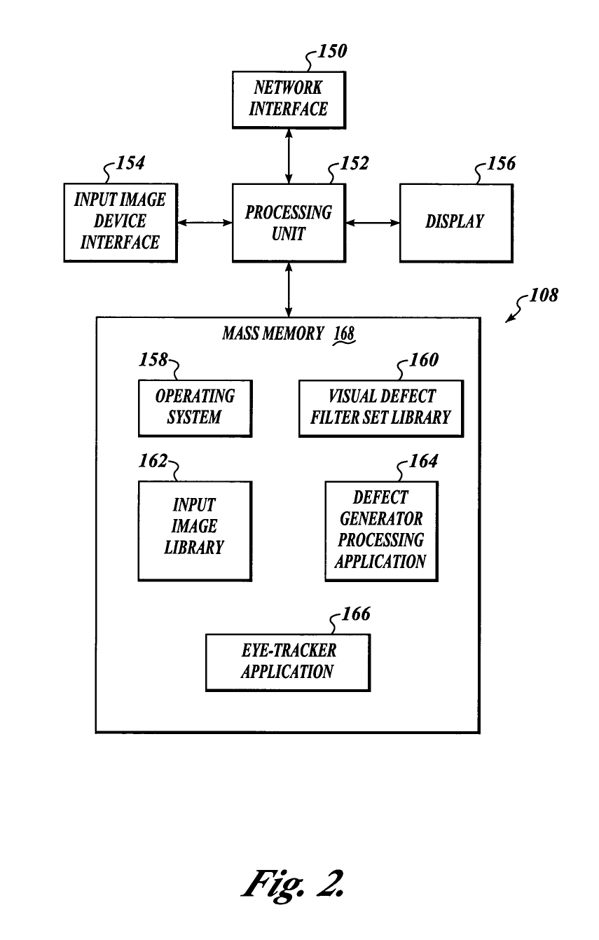

FIG. 2 is block diagram of an illustrative architecture for image modifying computer 108 (FIG. 1) suitable for use in the system according to the present invention. Those of ordinary skill in the art will appreciate that the computer may include many more components than those shown in FIG. 2. However, it is not necessary that all of these generally conventional components be shown in order to disclose an illustrative embodiment of the invention. As shown in FIG. 2, the image modifying computer 108 may include a network interface 150, a processing unit 152, an input image device interface 154, a display 156 and a memory 168. Those of ordinary skill in the art will appreciate that the network interface 150 includes the necessary circuitry for connecting directly to a LAN or WAN, or for connecting remotely to a LAN or WAN and is also constructed for use with various communication protocols, such as the TCP/IP protocol, the Internet Inter-ORB Protocol, and the like. The device interface 154 includes hardware and software components that facilitate interaction with a device that provides an input digital image, such as video camera 106 (FIG. 1). The processing unit 152 is of sufficient power and speed to provide real-time processing of an input digital image, such as for example, a commercially available digital media processor (for example, the Texas Instruments TMS® 320c6000 digital media processors).

With continued reference to FIG. 2, memory 168 generally comprises a random access memory (“RAM”), a read-only memory (“ROM”) and a permanent mass storage device, such as hard disk drive, tape driver, optical drive, floppy drive, CD-ROM, DVD-ROM or removable storage drive. The memory 168 stores an operating system 158 for controlling the operation of computer 108. The memory 168 also includes a defect generator processing application 164, a visual defect filter set library 160, an input image library 162 and an eye-tracker application 166. The memory 168, display 156, network interface 150, input image device interface 154, are all connected to the processor 152 via a bus. Other peripherals may also be connected to the processor in a similar manner. Additionally, one skilled in the art will appreciate that image modifying computer 108 may be embodied in a variety of computing devices including desktop personal computers, server computers, and the like. The system may optionally include further provisions for adjusting to the user's accommodative responses, vergence correction and for alleviation of simulator sickness (see e.g., U.S. Pat. No. 6,497,649, Lin et al., Proceedings of 46th Annual Meeting of Human Factors and Ergonomics Society, (2002) pp. 2124-2128, Peli et al., SID Digest Vol 32:1296-1299, (2001)).

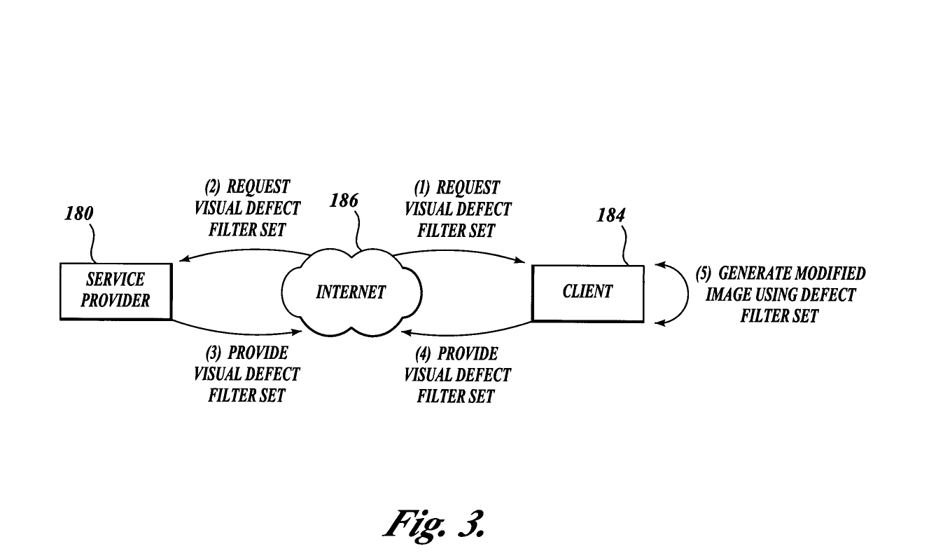

FIG. 3 is a block diagram of the visual image modification system 100 (FIG. 1) illustrating the transfer of a visual defect filter set between a client server 184 and a remote service provider 180. In the embodiment of the system shown in FIG. 3, visual defect filter sets are stored in a filter set database operably coupled to the user's server 184 accessible via the Internet 186. In operation, the user is positioned in front of the display device connected to client server 184 which may also optionally contain an eye tracking device. The user selects a particular visual defect for simulation and the appropriate filter sets are downloaded to the client server 184 from a database at a remote location. As shown in FIG. 3, two-way communication may be initiated by the selection of a service provider 180 by the client computer 184. Once a connection has been established, the client computer 184 may configure the transmission of a request for a particular visual defect filter set, as shown in the embodiment depicted in FIG. 3. In other alternative embodiments, the client computer 184 may transmit a digital image to be modified with a defect generator stored by the service provider 180. In another embodiment, an eye tracker system is operably coupled to the client computer 184. The remote service provider 180 receives the eye tracker signal and sends an appropriate preprocessed field of view image via the Internet 186 to the client computer 184.

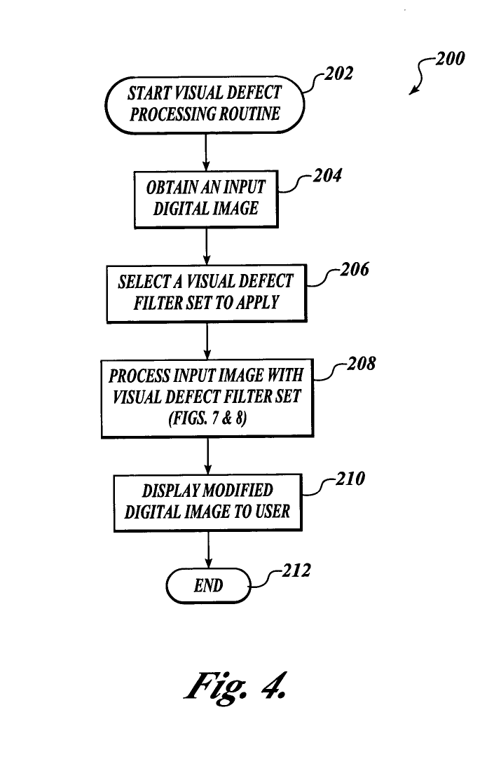

In another aspect, the present invention provides methods for simulating a visual defect to a user. A representative visual defect processing routine in accordance with this aspect of the invention is shown in FIG. 4. The visual defect processing routine 200 comprises the steps of obtaining an input digital image 204, selecting a visual defect filter set to apply 206, processing the input image with the visual defect filter set 208 and displaying the modified digital image to the user 210 to simulate the visual defect. The computer systems for simulating visual defects described herein are useful in the practice of the methods of this aspect of the invention.

With reference to FIG. 4, input digital image 204 may be obtained from any source that produces a digital image, such as for example, a digitized still image, a stored digital image, a computer generated image or a live video digital image. The scene chosen for the input digital image may be of any type. Generally, the scene is selected to represent the user's familiar surroundings and activities, such as, for example, reading, working at the computer, driving, walking through the home, and the like. It will be understood that the scene does not have to reference the specific user, but may depict a more generic scene that will be relevant to a general audience of users.

Referring again to FIG. 4, once digital input image 204 is obtained, a visual defect filter set is selected 206 to apply to the input image. In operation, the user is presented with a library of available visual defect simulations to choose from, and the selection of a particular visual defect filter set is based on which visual defect simulation the user wants to view. Any visual defect may be simulated using the methods of this aspect of the invention. By way of example, the methods of this aspect of the invention can be used to simulate macular degeneration as a loss of central resolution leading to development of a central scotoma. In another example, retinitis pigmentosa can be simulated by demonstrating the severe bilateral loss of peripheral visual field, resulting in near total night blindness, while maintaining a small central field with 20/20 acuity. Additional illustrative examples of visual defects that can be simulated in accordance with the present invention are described in Examples 1-3 and shown in TABLE 2 and TABLE 3. In some embodiments, the visual defect filter sets are stored in a computer-readable media. In other embodiments, the visual defect filter set is accessed remotely.

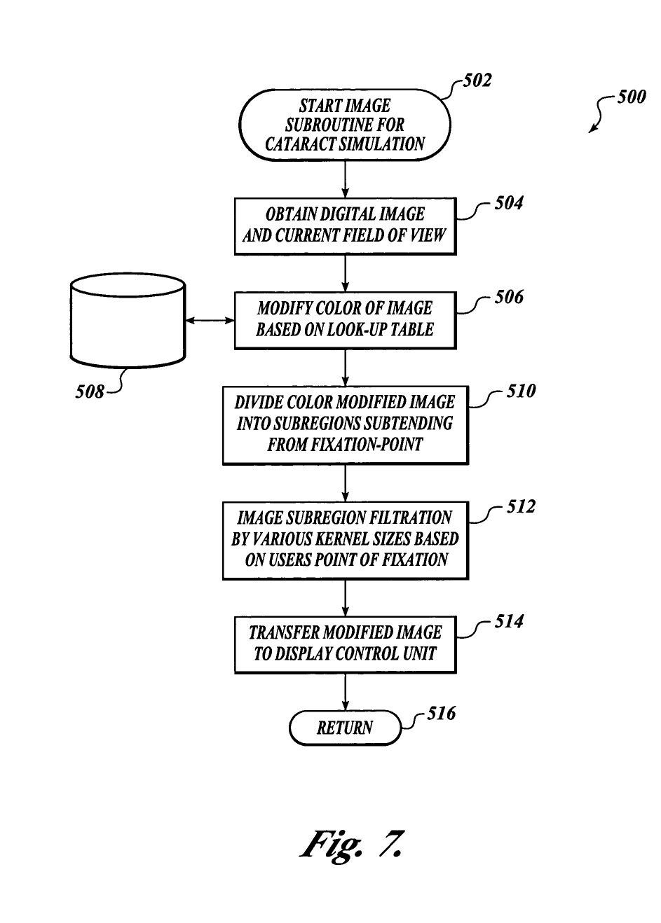

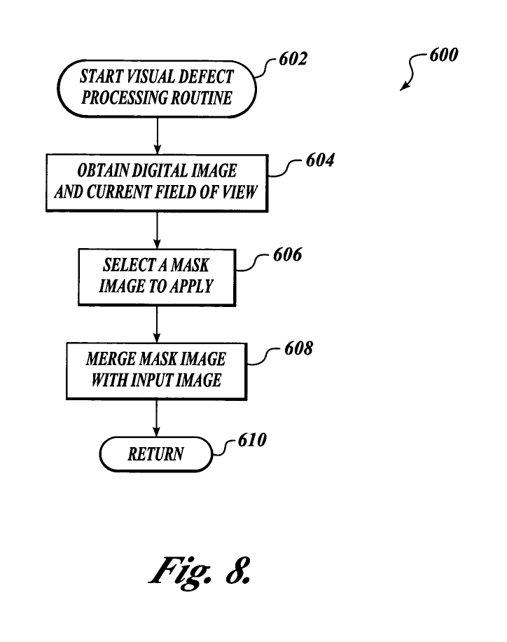

With continued reference to FIG. 4, the visual defect filter set 206 is created by a defect generator programmed to create a plurality of selectable visual defect filter sets, each performing a different predetermined modification corresponding to different visual defect parameters as further described in Examples 1 and 2 and shown in TABLES 1-3. Each visual defect can be simulated individually or in combination with others. Referring again to FIG. 4, once a particular visual defect filter set is selected 206, the filter set is used to process the input image 208 as further described below (in reference to FIG. 7 and FIG. 8), and generate a modified digital image which is displayed to the user 210.

Referring again to FIG. 4, the modified image may be displayed to the user 210 using any display device that allows the viewer to view the modified image. The choice of display devices depends on the desired level of sense of immersion for the user. Immersion level is generally believed to be the product of several parameters including level of interactivity, such as eye tracking, image complexity, stereoscopic view, field of regard and the update rate of the display. For example, the use of eye tracking and a stereoscopic view will generally serve to increase the experience for the user and more closely simulate an actual visual defect, in comparison to a monoscopic view with no eye tracking. In some embodiments, the display is a wide field of view (FOV) stereographic display or non-stereographic display such as a video rear projection onto a translucent hemispheric dome. In some embodiments, the display is mounted on a wearable headpiece. In some embodiments, the modified image is displayed on a transparent or semi-transparent surface, allowing the user to view both the modified image and a real-world image simultaneously. In some embodiments, the modified image is displayed on an occluded surface, so that only the displayed image is visible to the user.

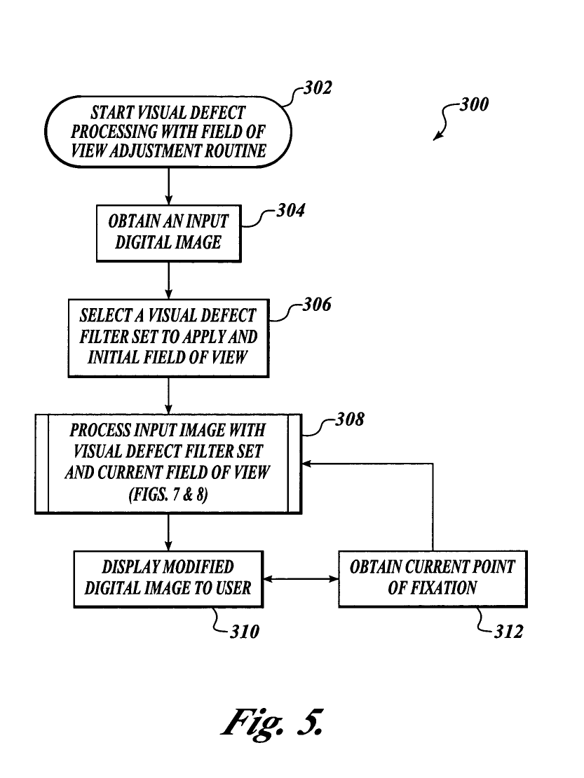

In some embodiments, the method of this aspect of the invention further comprises tracking at least one of the user's eyes while viewing the modified image to determine the user's point of fixation wherein the eye tracking input is used for real time processing and display of a correctly oriented and modified field of view image. FIG. 5 illustrates one embodiment of a visual defect processing routine with field of view adjustment 300 which comprises the steps of obtaining an input digital image 304, selecting a visual defect filter set to apply and initial field of view 306, processing the input image with visual defect filter set and current field of view 308 and displaying the modified digital image to the user 310, wherein the user's point of fixation is constantly monitored and the updated point of fixation of the user is obtained 312 and processed with the visual defect filter set 308 to display the properly oriented field of view 310. The user's point of fixation may be obtained 312 by an eye tracking device that measures pupil direction of the user while the user views the displayed image 310.

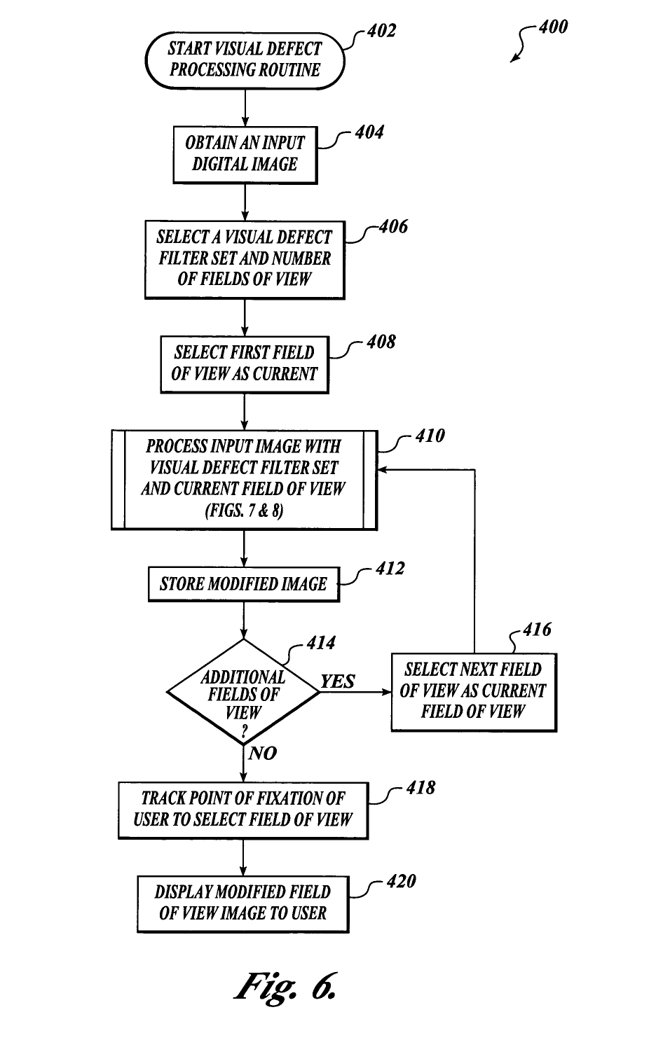

In further embodiments of the method of this aspect of the invention, the modified image is pre-processed and stored in a computer memory prior to display. FIG. 6 illustrates one embodiment of visual defect processing routine 400 comprising obtaining an input digital image 404, selecting a visual defect filter set to apply and the number of fields of view to be processed 406, selecting the first field of view as current 408, processing the current field of view with the visual defect filter set 410 (as described in FIGS. 7 and 8), storing the modified image 412 and processing additional fields of view if desired 414, wherein the next field of view is selected as the current field of view 416. A particular stored modified image in the appropriate field of view is selected from the set of stored images 412 based on the point of fixation of the user 418, and the appropriate field of view image is then displayed to the user 420.

Referring again to FIG. 6, images processed in different fields of view 410 may be processed into a set of images corresponding to a predetermined number of different fields of view. Such modified images can be stored 412 on a computer-readable medium and loaded into memory of a computing device using a drive mechanism associated with the computer-readable medium, such as a floppy disk drive, CD-ROM, DVD-ROM drive, or may be shared across a network as described herein.

With reference now to FIG. 7, an illustrative routine 500 implemented by a computer processor for processing a digital image for cataract simulation will be described. One skilled in the art will appreciate that the disclosed embodiment is illustrative in nature as one example of a visual defect simulation based upon the parameters for cataract defects and should not be construed as limiting the scope of the invention. As shown in TABLE 2, cataracts fall into the categories of nuclear, cortical or posterior subcapsular. For a nuclear cataract, the visual defect is a gradual color filtration progressing from light yellow to dark brown. Additionally, there is a progressive overall haze with decreased contrast sensitivity. In each of the previously described embodiments of the method of this aspect of the invention, once the user selects nuclear cataract as the visual defect filter set to apply (see 206 (FIG. 4), 306 (FIG. 5) and 406 (FIG. 6)), processing routine 500 is initiated as shown in FIG. 7. At block 504, a digital image and current field of view are transferred to the processor. The color of the image is modified 506 by changing the red, green and blue components of each color based on information in the look-up table 508. A description of how the data in look up table 508 was derived is provided in Example 2. At block 510, the color modified image is divided into concentric subregions subtending from the user's point of fixation. At block 512, the subregions of the image are filtered by various kernel sizes based on the user's point of fixation. A more detailed description of the use of filter kernels to modify a digital image is provided in Example 1. The modified image is then transferred to the display control unit 514 and is returned 516 to the visual defect processing routine to be displayed to the user (as shown in 210 (FIG. 4), 310 (FIG. 5) and 420 (FIG. 6)).

In brief, image filtering using filter kernels involves transforming the intensity of each pixel using a set of algorithms embodied in a computer readable medium designed to create a desired effect. An input digital image is provided, for example, from a CCD camera wherein the content of each CCD cell is assigned to the content of a corresponding pixel. Once in pixel form, linear filtering can transform images in many ways such as, for example, sharpening the edges of objects, reducing random noise, correcting for unequal illumination, and deconvolution to correct for blur and motion, etc. These procedures are carried out by convolving the original input image with an appropriate filter kernel to produce the filtered, modified output image (see e.g., Russ, J. C., The Image Processing Handbook 2nd Ed. CRC Press, Boca Raton, Fla. (1995)).

It will be understood by one of skill in the art, that in accordance with the methods and image modification techniques described herein, a particular visual defect filter set or combination of filter sets will be selected based upon the desired defect and applied to an input digital image to generate a transformed image that simulates the visual defect. Once the characteristics of a particular visual defect are known, a filter set can be designed to simulate the characteristic defects. For example, as described in TABLE 2 and TABLE 3, certain visual defects are characterized by a loss of central resolution, such as, for example, early stage macular degeneration, albinism, amblyopia and diabetic retinopathy. Other visual defects are characterized by a loss of peripheral vision, such as, for example, chronic glaucoma, retinitis pigmentosa and certain brain tumors. Some visual defects are characterized by a loss of color filtration, such as, for example, cataract. Some visual defects are characterized by other effects such as glare (cataracts, corneal irregularities), halos (glaucoma), scintillating flickering lines (migraine) and peripheral light flashes (retinal tear and detachment).

In another aspect, the present invention provides a method for simulating a visual defect to a user comprising tracking at least one of the user's eyes to determine the user's point of fixation while the user views an image, selecting a mask image to simulate a visual defect and displaying the mask image to the user wherein the position of the mask image display is determined by the user's point of fixation. In some embodiments, the mask image is displayed on a see-through display surface so that the user views the mask as an image that is superimposed upon a real-world image. In other embodiments, an input digital image is merged with the mask image by combining the images on a video graphics card. With reference now to FIG. 8, an illustrative processing routine 600 of one embodiment of the method of this aspect of the invention is depicted comprising the steps of obtaining a digital image and current field of view 604, selecting a mask image to apply 606, and merging the mask image with the input image 608 to create a modified image. The modified image is then returned 610 to the visual defect processing routine to be displayed to the user (as shown in 210 (FIG. 4), 310 (FIG. 5), and 420 (FIG. 6)).

The mask image 606 is selected based on the defect to be simulated such as, for example, a dark scotoma that may be superimposed over a second image. With the use of the eye tracker, the defect mask moves as the point of fixation of the user moves, providing an experience similar to a person suffering from macular degeneration. Non-limiting examples of additional visual defects that exhibit a scotoma include macular degeneration, coloboma of the choroid, diabetic retinopathy, eclipse burn, pre-retinal hemorrhage, Stargardt's disease, and vascular occlusion. Also, a mask can be used to simulate “floaters” in visual defects such as, for example, vitreous hemorrhage and retinal tear and detachment. The mask can be adjusted to track in the center or off-center with respect to the user's point of fixation in order to accurately simulate a particular visual defect.

In some embodiments, a processing routine that filters an image using a visual defect filter set as described in FIG. 4 is used to create a mask image that can be displayed on a see through display device to allow the user to view the modified image superimposed upon a real-world image. In some embodiments, the processing routine that filters an image can be used to create a mask image which may be merged with a modified image.

The following examples merely illustrate the best mode now contemplated for practicing the invention, but should not be construed to limit the invention. All literature citations herein are expressly incorporated by reference.

### EXAMPLE 1

This example describes the method of generating a visual defect filter set that will generate a predictable modification of an image that is useful for simulation of various visual defects.

Methods:

Nine subjects with normal vision were used in this study. The subjects were seated at a fixed distance from a 21″ CRT screen which subtended a visual angle of ±6° from primary position horizontally, and ±5° vertically. Experiments were conducted in ambient lighting and subjects were comfortable and relaxed during the experiment which took approximately 45 minutes per subject.

The normal visual acuity of each subject was tested in the following way: the subject was asked to identify certain optotypes of the same size that flashed on the screen using unprocessed images. Acceptance criteria required the subject to correctly identify at least three out of five displayed optotypes of the same size, in a manner similar to that used by an ophthalmologist to test visual acuity using Snellen charts. Once normal visual acuity was determined, each subject was presented with an image that was filtered using a series of kernel size filters (i.e., 3×3, 5×5, 7×7, 9×9, etc) and the subject was evaluated to determine the level of reduced visual acuity.

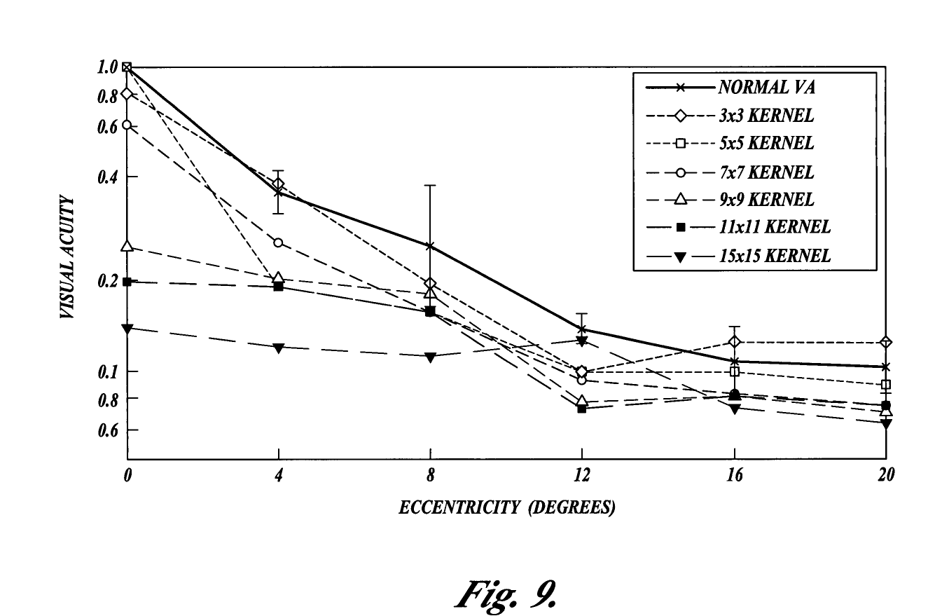

Results: As shown in FIG. 9, plotting the foveal and near peripheral visual acuity values (shown on the y-axis as eccentricity, the distance from the foveal center) for each filter size revealed average reductions in the visual acuity as follows: a 3×3 filter reduced acuity by 20%, a 5×5 filter reduced acuity by 38%, a 7×7 filter reduced acuity by 60% and a 9×9 filter reduced acuity by 81%. Based upon this data, an algorithm was developed to modify a digital image to simulate degradation of vision experienced during cataract development. The degradation was calculated as a function of visual acuity drop verses the kernel size used at ±1°, ±2°, ±3°, ±4°, ±5°, and ±6° from retinal eccentricity.

### EXAMPLE 2

This example describes the method of generating a model that simulates the change in contrast sensitivity and color perception that occurs in cataract development as well as the loss of visual acuity experienced in subjects with macular degeneration.

Methods:

Contrast Sensitivity

Starting from established case studies (Vistech Consultants, Inc., 1987, The VCT and MCT Contrast Sensitivity Test System), hypothetical models were constructed of macular degeneration and cataracts that predict how the contrast sensitivity of normal human vision drops across retinal eccentricity. The model was tested by measuring the contrast sensitivity of subjects having visual abnormalities in only one eye. The simulator used in these experiments consisted of an ISCAN® eye tracker (monocular at 240 Hz), a computer processor to generate modified images using custom software in C++ and OpenGl, and a display system which displayed modified images on a 21″ CRT monitor that subtends a visual angle of ±20° from a primary position horizontally and ±15° vertically. Image modification was achieved in a systematic manner as described in Example 1. The visual abnormalities were displayed in a position relative to the fixation point of the subject. In a study with 18 subjects with vision problems in one eye only, the image degradation was verified to replicate the actual perceptual degradation of contrast sensitivity.

Color perception: Color vision studies were also conducted with patients with cataracts in one eye only, having had successful cataract/implant surgery in the other eye, to determine the effect of cataracts on color perception. The study involved measuring each subject's color perception with the unaffected, post-operative, eye and then again with the eye affected by cataract. A display monitor was used which was calibrated so that the gamma correction curve was linear. Using the data from this experiment, a “look-up” database was built for each color based on the combination of the red, green and blue components of each color. TABLE 1 provides several examples of colors that are perceived differently with or without cataracts. Color is added to digital images by using three numbers for each pixel, representing the intensity of the three primary colors:

red (“R”), green (“G”) and blue (“B”). Mixing these three colors (RGB) generates all possible colors that the human eye can perceive.

TABLE 1
COLOR PERCEPTION CHART

| Color Perceived w/o Cataract | Color Perceived with Cataract |
|---|---|
| light purple (R: 254; G: 0; B: 254) | dark purple (R: 159; G: 64; B: 254) |
| dark blue (R: 0; G: 0; B: 124) | light blue (R: 22; G: 9; B: 174) |
| dark green (R: 0; G: 124; B: 2) | light green (R: 65; G: 171; B: 73) |
| light gray (R: 200; G: 200; B: 200) | dark Grey (R: 165; G: 166; B: 184) |

Results:

Cataracts: Based on a model (Vistech Consultants, Inc., 1987, The VCT and MCT Contrast Sensitivity Test System) which predicted a 50% drop in visual acuity relative to the distance from foveal center as compared to normal visual acuity, combined with predicted changes in color perception and contrast sensitivity, a image processing routine was generated which combines color modification and sub-region filtration by various kernel sizes to simulate cataract defects to a normal subject. To accurately simulate the defect, the field of view of an input is subdivided into concentric zones starting at the axis of foveal fixation and moving out towards the periphery. Once the input image was modified with the image processing routine for cataract, a panel of 18 patients suffering from cataract in one eye and with normal visual function in the other eye were used to validate the accuracy of the model image. Image modification was achieved in a systematic manner to replicate the actual perceptual degradation of the contrast sensitivity by patients with vision problems. This was verified with 18 patients who had impaired vision in one eye only. Through the use of the eye tracker, the visual abnormality was displayed in a position relative to the fixation point of the subject.

Macular Degeneration

Macular degeneration was simulated using two different methods of image modification. In the first method, a map was generated based on the model for macular degeneration (Vistech Consultants, Inc., 1987, The VCT and MCT Contrast Sensitivity Test System) using various filter sizes across the image sub-regions to produce the scotoma effect. The simulation was made more realistic by monitoring the eye position of a subject viewing a simulation and orienting the filter map to the axis of foveal fixation.

Using a second method for simulating macular degeneration, a series of images were created as masks that contain a dark center that fades according to patterns observed by patients suffering from macular degeneration. These masks were stored in a computer database. To simulate an early stage of macular degeneration, an input image was modified as described above, using a model developed by Vistech Consultants which predicts relative visual acuity as a function of distance from the foveal center. Later stage macular degeneration was either simulated as described with a near total loss of resolution in the center, causing a dark spot, or alternatively, by superimposing the mask image of a dark spot onto the image viewed by the subject, or a combination of images stored on a graphics card. The eye tracker was used to move the defect according to the subject's point of fixation.

### EXAMPLE 3

This example provides an illustrative list of common conditions and impairments that may arise through disease or therapeutic intervention that may be simulated using the systems and methods of the present invention.

TABLE 2 provides an illustrative list of common conditions that result in visual impairment that may be simulated in accordance with the present invention. TABLE 3 provides an illustrative list of therapeutic impairments and visual prostheses that may be simulated in accordance with the present invention. The second column describing design criteria for the defect generator provides the characteristics of visual defects experienced by the patients with the disease. The techniques for achieving the particular defects are provided in Examples 1 and 2 and elsewhere herein. While it is understood that eye tracking always provides a more realistic simulation experience, accurate simulation of certain visual defects requires eye tracking as described.

TABLE 2
COMMON CONDITIONS

| | | Eye Tracking |
|---|---|---|
| Visual Impairment | Design Criteria for defect generator | required |
| Age related macular | | |
| degeneration | | |
| a) Dry Type | May be binocular, may be unequal, | YES |
| | typically gradual irregularly progressive | |
| | loss of central resolution followed by vague | |
| | development of a central scotoma. | |
| b) Wet Type | May be binocular, but usually unequal, | YES |
| | sudden central scotoma with a sense of | |
| | darkness. | |
| Albinism | Congenital absence of the uveal pigment | YES |
| | usually associated with nystagmus and | |
| | bilateral amblyopia, results in poor central | |
| | resolution and severe glare. | |
| Amblyopia | | |
| a) Monocular | Most caused by strabismus in childhood | YES |
| | resulting in a loss of central resolution, in | |
| | some cases to the point of loss of central | |
| | fixation. | |
| b) Binocular | Most often occurring in albinism or | YES |
| | nystagmus. Loss of central resolution in | |
| | both eyes. | |
| Aniridia | Congenital absence of the iris which causes | NO |
| | a severe sensitivity to brightness. | |
| Brain Tumor | | |
| a) Pre-chiasmal lesion | Monocular peripheral field defect. | YES |
| b) Chiasmal lesion | Typically bitemporal hemianopsia. | YES |
| c) Post-chiasmal lesion | Binocular field defect with varying level of | YES |
| | congruity. | |
| Cataract | | |
| a) Nuclear | Gradual color filtration progressing from | NO |
| | light yellow to dark brown. Progressive | |
| | overall haze with decreased contrast | |
| | sensitivity and increasing glare from high | |
| | contrast light sources. | |
| b) Cortical | Little color filtration, progressive overall | NO |
| | haze with decreased contrast sensitivity and | |
| | glare around high contrast light sources. | |
| c) Posterior subcapsular | No color filtration. Striking glare around | NO |
| | high contrast light sources and eventual | |
| | haze development. | |
| Coloboma of the choroid | May be binocular. Absolute scotoma | YES |
| | extending superiorly from the point of | |
| | fixation. | |
| Colorblindness | A bilateral diffuse loss of color saturation | NO |
| | may vary from moderate loss of specific | |
| | colors to total absence of color perception. | |
| Corneal irregularities | Most often the result of injury, corneal | NO |
| | ulceration, keratoconus or complication of | |
| | refractive surgery. Monocular or binocular | |
| | producing a diffuse series of halos, glare, | |
| | and ghosting around high contrast light | |
| | sources. | |
| Diabetic retinopathy | Most often macular edema, may be | YES |
| | monocular or binocular and producing loss | |
| | of central resolution and vague central | |
| | scotoma. May experience severe vitreous | |
| | hemorrhage (see below). | |
| Eclipse Burn | May result from unprotected eclipse | YES |
| | viewing or inadvertent exposure to laser or | |
| | electric arc. Monocular or binocular | |
| | produces a small dense macular or perimacular | |
| | scotoma. | |
| Glaucoma | | |
| a) Acute | Usually monocular causing colorful halos | NO |
| | and rainbows around high contrast light | |
| | sources. | |
| b) Chronic | Monocular or binocular but unequal. | YES |
| | Slowly progressive loss of peripheral field | |
| | of vision with interim development of | |
| | bearing of the blind spot and the nasal step. | |
| | May progress to a remaining small central | |
| | field with good acuity which may also | |
| | extinguish. | |
| Hemorrhage | | |
| a) Hyphema | Usually traumatic. Usually monocular. | NO |
| | Mild, may result in a pink or reddish filter | |
| | over the entire visual field which may be | |
| | worse immediately following saccade then | |
| | gradually clear. Severe hyphema | |
| | completely obscures the visual field. | |
| b) Vitreous hemorrhage | Monocular or binocular. May completely | YES |
| | obscure vision or may appear as irregular | |
| | and variable large floaters with a sense of | |
| | dribbling or streaking and may break up | |
| | into innumerable tiny black spots. | |
| c) Pre-retinal | Usually monocular. Usually central or | YES |
| | paracentral with a dense irregular scotoma. | |
| Migraine | Binocular and exactly equal. May begin in | YES |
| | the peripheral, mid-peripheral or central | |
| | visual field. Often with a sense of | |
| | flickering or jagged or zig-zaggy lines | |
| | which may be colored. The scintillating | |
| | image replaces the normal visual image. It | |
| | may enlarge, reduce, move in the visual | |
| | field, and may move from one side of the | |
| | visual field to the other. As the | |
| | phenomenon passes and vision returns to | |
| | normal, the area of the scotoma is often | |
| | replaced by a shimmering sense of | |
| | brightness very much like the dance of | |
| | sunlight on a water surface. | |
| Retinal tear and detachment | Normally monocular and usually beginning | YES |
| | with combined peripheral light flashes and | |
| | the abrupt development of floaters. The | |
| | floaters have a character of small vitreous | |
| | hemorrhages (see above) while the flashing | |
| | is in the far periphery, may be superior or | |
| | inferior and has the character of a camera | |
| | flash. A developing retinal detachment | |
| | appears as a dark, gray, brown, or black | |
| | defect in the peripheral vision in any | |
| | meridian having a smooth curved inner | |
| | margin. Extension of the retinal | |
| | detachment may cause its field defect to | |
| | enlarge even reaching or passing the point | |
| | of central fixation but also with loss of | |
| | central resolution. | |
| Retinitis Pigmentosa | A primary pigmentary degeneration of the | YES |
| | retina. Usually bilateral with a progressive | |
| | loss of peripheral vision symmetrically | |
| | encroaching on the point of fixation. May | |
| | progress to leaving only a few degrees of | |
| | central visual field but still with normal | |
| | resolution, rarely progresses to total | |
| | blindness. | |
| Stargardt's disease | A juvenile form of macular degeneration. | YES |
| Strabismus | | |
| a) childhood | often leads to amblyopia (see above). | YES |
| b) Adult | Acquired, usually paralytic strabismus, | YES |
| | results in persistent diplopia present only in | |
| | the field of action of the paralytic muscle. | |
| Subluxation of lens | Usually monocular following trauma or | YES |
| | developing Marfan's syndrome. Results in | |
| | monocular diplopia where the secondary | |
| | image is enlarged approximately six or | |
| | eight percent, moderately less intense and | |
| | seriously out of focus (20 diopters). | |
| Vascular Occlusion | | |
| a) Branch retinal arteriole | Results in a wedge-shaped scotoma | YES |
| | extending from the point of blockage out | |
| | toward the periphery. | |
| b) Central retinal vein occlusion | Usually results in a very severe dimming of | YES |
| | the overall field of vision almost to the | |
| | point of blackness. With time, there is a | |
| | blotchy return of irregular patches in the | |
| | visual field still quite dim and with no | |
| | useful central resolution. | |
| Vitreous floaters | Monocular or binocular but unequal. Most | YES |
| | often dark with appearance of dust or lint. | |
| | May occur as a large grayish shadow. | |
| | Often move following a saccade, thus the | |
| | term floater. | |

TABLE 3
THERAPEUTIC IMPAIRMENTS AND VISUAL PROSTHESIS

| | | Eye Tracking |
|---|---|---|
| Therapeutic Treatment | Design Criteria for defect generator | beneficial |
| Laser | | |
| a) Macular and paramacular | Causes small scotoma | YES |
| b) Panretinal photocoagulation | Causes mild decreased peripheral acuity | NO |
| Surgery | | |
| a) Scleral buckle | Causes a far peripheral ring field defect | YES |
| b) Epiretinal membrane | | YES |
| stripping. | | |
| Low Vision | | |
| a) Optical and video external | Produce enlarged image which may be | YES |
| magnification devices | resolved by the limited acuity of the | |
| | peripheral field. | |
| b) “Bullseye” intraocular lens | Produces a diplopic magnified image | YES |
| implant | | |
| Pharmaceutical | | YES |
| a) Photodynamic therapy | In which a pharmacologic agent sensitizes | YES |
| | abnormal vessels causing photic energy to | |
| | produce localized injury. | |
| b) Angiotensive agents | Which stimulate neovascular growth in | YES |
| | ischemic areas. | |
| Biologic Implantation | | |
| a) Pigment epithelial cell | | YES |
| implantation | | |
| b) Retinal stem cell implantation. | | YES |
| Visual Prostheses | | |
| 1. Retinal chip implantation. | | YES |
| 2. Sensitization of second | To cause direct visual stimulation thus | YES |
| neurons | bypassing the neurosensory retina. | |

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method for simulating a visual defect to a user comprising:
obtaining an input digital image;
selecting a visual defect filter set to apply to said input digital image;
processing said input digital image with said visual defect filter set to generate a modified digital image; and
displaying said modified digital image to the user to simulate the visual defect.

2. The method as recited in claim 1, wherein said input digital image is stored in the memory of a computer.

3. The method as recited in claim 1, wherein said input digital image is a live image captured by the user.

4. The method as recited in claim 1, wherein said input digital image is captured via video camera.

5. The method as recited in claim 4, wherein said video camera is mounted on the head of the user.

6. The method as recited in claim 1, wherein said input digital image is captured and processed in stereo.

7. The method as recited in claim 1, further comprising storing said modified digital image in the memory of a computer.

8. The method as recited in claim 7, wherein said modified stored image is processed to represent various fields of view.

9. The method as recited in claim 8, further comprising tracking at least one of the user's eyes while the user views the modified image to determine the user's point of fixation wherein the user's point of fixation guides the selection of an image from the set of stored preprocessed images in various fields of view.

10. The method as recited in claim 1, further comprising tracking at least one of the user's eyes while the user views the modified image to determine the user's point of fixation wherein the displayed image is dynamically processed with the eye tracking data to maintain a constant orientation between the simulated visual defect and the user's point of fixation.

11. The method as recited in claim 1, wherein said modified image is displayed in a wide field of view stereographic display.

12. The method as recited in claim 1, wherein said modified image is displayed on a head mounted display.

13. The method as recited in claim 10, wherein said modified image is displayed on a see-through surface.

14. The method as recited in claim 1, wherein said visual defect is selected from the group consisting of macular degeneration, albinism, amblyopia, aniridia, brain tumor, cataract, coloboma of the choroid, colorblindness, corneal irregularity, diabetic retinopathy, eclipse burn, glaucoma, hyphema hemorrhage, vitreous hemorrhage, pre-retinal hemorrhage, migraine, retinal tear and detachment, retinitis pigmentosa, Stargardt's disease, strabismus, subluxation of lens, vascular occlusion, branch retinal arteriole, central retinal occlusion, vitreous floaters and the effects of therapeutic modalities.

15. The method as recited in claim 1 wherein said input image is modified to simulate a scotoma.

16. The method as recited in claim 1 wherein said input image is modified to simulate a cataract.

17. The method as recited in claim 1 wherein said input image is modified to simulate a reduction in peripheral vision.

18. A computer-readable medium having computer-executable instructions for performing the method recited in claim 1.

19. A computer-readable medium having computer-executable instructions for performing the method recited in claim 9.

20. A computer-readable medium having computer-executable instructions for performing the method recited in claim 10.

21. A set of pre-modified digital images embodied on a computer-readable memory medium generated to simulate a visual defect using the computer executable instructions as recited in claim 18.

22. A method for simulating a visual defect to a user comprising:
tracking at least one of the user's eyes while the user views an image to determine the user's point of fixation;
selecting a mask image to simulate a visual defect; and
displaying said mask image to the user wherein the mask image position is determined by the user's point of fixation to generate two superimposed images which simulates a visual defect.

23. The method of claim 22, wherein said mask image is displayed to the user on a see-through surface.

24. The method of claim 22, further comprising obtaining an input digital image, merging said mask image with said input image and displaying said merged image to simulate a visual defect.

25. A computer system comprising a processor, a memory, and an operating environment, the computer system operable to perform the method as recited in claim 1.

26. A computer system for simulating visual defects to a user, the computer system comprising:
means for obtaining an input digital image, a memory, a processing unit, means of modifying said input image to simulate a visual defect and a display device to display said modified image to the user to simulate the visual defect.

27. The computer system as recited in claim 26, further comprising an eye tracking device, wherein the eye tracking device measures the user's point of fixation while the user views said displayed image and wherein said eye tracking device is interfaced with said processing unit.

28. The computer system as recited in claim 26, wherein at least one of the system components is accessed remotely on a network.
